(19) United States
(12) Patent Application Publication
(10) Pub. No.: US 2012/0172504 A1
(43) Pub. Date: Jul. 5, 2012

(54) Flameproof Thermoplastic Resin Composition

(75) Inventors: Kyuong Sik CHIN, Uiwang-si (KR); Seung Shik SHIN, Uiwang-si (KR); Yun Ku NAM, Uiwang-si (KR); Hwan Seok PARK, Uiwang-si (KR)

(73) Assignee: CHEIL INDUSTRIES INC., Gumi-si (KR)

(21) Appl. No.: 13/339,781

(22) Filed: Dec. 29, 2011

(30) Foreign Application Priority Data
Dec. 31, 2010 (KR) 10-2010-0140735
Sep. 1, 2011 (KR) 10-2011-0088704

(51) Int. Cl. C08L 51/04; C08L 69/00; C08L 25/06; C08K 5/523

(52) U.S. Cl. 524/127

(57) ABSTRACT

A thermoplastic resin composition includes a polycarbonate resin/impact modifier system, a polystyrene resin having a predetermined molecular weight, and a phosphorus flame retardant. The impact modifier includes a particular rubber particle size and is formed of particular monomers. The composition can exhibit improved flame retardancy, impact resistance, fluidity, and appearance.

### CROSS-REFERENCE TO RELATED APPLICATIONS

This application claims priority under 35 USC Section 119 to and the benefit of Korean Patent Application No. 10-2010-0140735, filed Dec. 31, 2010, and Korean Patent Application No. 10-2011-0088704, filed Sep. 1, 2011, the entire disclosure of each of which is incorporated herein by reference.

### FIELD OF THE INVENTION

The present invention relates to flameproof thermoplastic resin compositions.

### BACKGROUND OF THE INVENTION

Polycarbonate/acrylonitrile-butadiene-styrene (PC/ABS) alloy resins can have excellent processing properties and mechanical properties due to the combination of PC, which can have excellent heat resistance and impact strength, and an ABS copolymer, which can have processability and chemical resistance. Further, the PC/ABS alloy resin can have superior physical properties as compared to ABS and can be less expensive than PC. Thus, PC/ABS alloy resins can be used for various purposes. For example, a non-halogenated (NH) PC/ABS resin, which contains no halogen, does not cause environmental contamination and is not harmful to the human body, and thus it is widely used for various electronic products and automobile components, such as monitor housings, hard disks, printers, notebook batteries, door handles, bumpers, and instrument panels, among others.

HN-PC/ABS generally includes polycarbonate, ABS, and a phosphorus flame retardant, and is commonly used for exterior materials of electronic products requiring high gloss, high fluidity and high impact resistance. The content of rubber used as an impact modifier is generally determined by the particle size thereof, and impact resistance, appearance and gloss of the resin are determined depending on proper selection of rubber and a dispersion method. However, PC has weak affinity with ABS (impact modifier) and ABS cohesively agglomerates and exhibits low dispersion efficiency in the PC resin matrix, thereby making it difficult to obtain desired impact strength.

Further, PC/ABS blends can be used for exterior materials of products requiring a good appearance, such as TVs. PC/ABS blends, however, do not meet high quality appearance requirements for such applications, due to limited coloring ability of the styrene-acrylonitrile (SAN) copolymer of the ABS resin.

### SUMMARY OF THE INVENTION

The present invention provides a flameproof thermoplastic resin composition including a polycarbonate resin/impact modifier system, a polystyrene resin having a predetermined molecular weight, and a phosphorus flame retardant. The impact modifier has a particular rubber particle size and is formed of particular types of monomers. Also, the amount of each component can be adjusted to significantly improve dispersibility of the impact modifier in a thermoplastic resin, which can enhance flame retardancy, impact resistance, fluidity, and appearance.

The flameproof thermoplastic resin composition includes about 50 to about 95 parts by weight of a polycarbonate resin (a), about 1 to about 30 parts by weight of a polystyrene resin (b), about 1 to about 30 parts by weight of an impact modifier (c), and about 1 to about 20 parts by weight of a phosphorus flame retardant (d) based on about 100 parts by weight of the base resin including (a), (b) and (c). The polystyrene resin (b) has a weight average molecular weight of about 200,000 to about 400,000 g/mol, and the impact modifier (c) includes a rubber modified vinyl graft copolymer (cl) containing a rubber polymer having an average particle size of about 0.05 to about 0.5 μm and an acrylic shell containing core-shell graft copolymer (c2) containing a rubber polymer having an average particle size of about 0.05 to about 0.5 μm. As used herein, the term average particle size of a rubber polymer refers to volume based average particle size measured in accordance with techniques well known to the skilled artisan.

The rubber modified vinyl graft copolymer (c1) and the acrylic shell containing core-shell graft copolymer (c2) may be included in a mixture ratio of about 1:1 to about 1:3.

The rubber modified vinyl graft copolymer (cl) may be prepared by graft polymerization of a monomer mixture including a rubber polymer, an aromatic vinyl compound, and a vinyl cyanide compound.

The acrylic shell containing core-shell graft copolymer (c2) may be prepared by grafting a rubber polymer polymerized from a diene monomer, an acrylic monomer, a silicon monomer or a combination thereof with an unsaturated compound including an acrylic monomer, a heterocyclic monomer, an aromatic vinyl monomer, an unsaturated nitrile monomer or a combination thereof, wherein the unsaturated compound may include at least one acrylic monomer.

The polycarbonate resin may have a melt index of about 5 to about 100 g/10 min (1.2 kg, 300° C., ISO 1133).

The thermoplastic resin may have an impact strength of about 45 to about 55 kgf·cm/cm (⅛″, ASTM D256), a melt index of about 100 to about 115 g/10 min (10 kg, 220° C., ISO 1133), and a flammability rating of V-0 (2 mm, UL94).

The present invention also provides a molded article formed of the flameproof thermoplastic resin composition.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

A flameproof thermoplastic resin composition according to the present invention includes about 50 to about 95 parts by weight of a polycarbonate resin (a), about 1 to about 30 parts by weight of a polystyrene resin (b), about 1 to about 30 parts by weight of an impact modifier (c), and about 1 to about 20 parts by weight of a phosphorus flame retardant (d) based on about 100 parts by weight of the base resin including (a), (b) and (c). The polystyrene resin (b) has a weight average molecular weight of about 200,000 to about 400,000 g/mol, and the impact modifier (c) includes a rubber modified vinyl graft copolymer (c1) containing a rubber polymer having an average particle size of about 0.05 to about 0.5 μm and an acrylic shell containing core-shell graft copolymer (c2) containing a rubber polymer having an average particle size of about 0.05 to about 0.5 μm.

Hereinafter, each component of the flameproof thermoplastic resin composition according to the present invention will be described in detail.

(a) Polycarbonate Resin

The polycarbonate resin may be prepared by reaction of one or more diphenols represented by Formula 1 with phosgene, halogen formate, or carbonic acid diester:

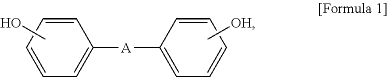

where A is a single bond, C1 to C5 alkylene, C1 to C5 alkylidene, C5 to C6 cycloalkylidene, —S—, or —SO2-.

Examples of the diphenols represented by Formula 1 include without limitation hydroquinone, resorcinol, 4,4′-dihydroxy diphenyl, 2,2-bis(4-hydroxyphenyl)propane, 2,4-bis(4-hydroxyphenyl)-2-methylbutane, 1,1-bis(4-hydroxyphenyl)cyclohexane, 2,2-bis(3-chloro-4-hydroxyphenyl)propane, 2,2-bis(3,5-dichloro-4-hydroxyphenyl)propane, and the like, and combinations thereof.

In exemplary embodiments, 2,2-bis(4-hydroxyphenyl)propane (also referred to as bisphenol A), 2,2-bis(3,5-dichloro-4-hydroxyphenyl)propane, and/or 1,1-bis(4-hydroxyphenyl)cyclohexane may be used.

The polycarbonate resin may be a branched chain polycarbonate resin, which may be prepared by addition of about 0.05 to about 2 mol % of a tri- or higher functional aromatic compound, e.g., a compound having a trivalent or higher valence phenol group, based on the total amount of diphenol used in polymerization.

The polycarbonate resin may have a weight average molecular weight (Mw) of about 10,000 to about 200,000 g/mol, for example about 15,000 to about 80,000 g/mol.

Further, the polycarbonate resin may have a melt index of about 5 to about 100 g/10 min at 1.2 kg and 300° C. according to ISO 1133. In one embodiment, the polycarbonate resin may include a mixture of polycarbonate resins having different melt indices, for example, a mixture including about 80 to about 99 wt % of a polycarbonate resin having a melt index of about 31 to about 100 g/10 min and about 1 to about 20 wt % of a polycarbonate resin having a melt index of about 5 to about 30 g/10 min.

In some embodiments, the polycarbonate resin may include the polycarbonate resin having a melt index of about 31 to about 100 g/10 min in an amount of about 80, 81, 82, 83, 84, 85, 86, 87, 88, 89, 90, 91, 92, 93, 94, 95, 96, 97, 98, or 99 wt %. Further, according to some embodiments of the present invention, the amount of the polycarbonate resin having a melt index of about 31 to about 100 g/10 min can be in a range from about any of the foregoing amounts to about any other of the foregoing amounts.

In some embodiments, the polycarbonate resin may include the polycarbonate resin having a melt index of about 5 to about 30 g/10 min in an amount of about 1, 2, 3, 4, 5, 6, 7, 8, 9, 10, 11, 12, 13, 14, 15, 16, 17, 18, 19, or 20 wt %. Further, according to some embodiments of the present invention, the amount of the polycarbonate resin having a melt index of about 5 to about 30 g/10 min can be in a range from about any of the foregoing amounts to about any other of the foregoing amounts.

When the polycarbonate resin has a melt index within this range, injection molding performance and appearance of a molded article may be improved.

The polycarbonate used for preparing the resin composition may include homopolycarbonate, copolycarbonate or a blend thereof. Further, the polycarbonate may be replaced partly or entirely by an aromatic polyester-carbonate resin, which is obtained by polymerization in the presence of an ester precursor, for example, bifunctional carboxylic acid.

The flameproof thermoplastic resin composition may include the polycarbonate resin in an amount of about 50 to about 95 parts by weight, based on about 100 parts by weight of the entire composition, for example about 65 to about 95 parts by weight, and as another example about 70 to about 90 parts by weight. In some embodiments, the flameproof thermoplastic resin composition may include the polycarbonate resin in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 parts by weight. Further, according to some embodiments of the present invention, the amount of the polycarbonate resin can be in a range from about any of the foregoing amounts to about any other of the foregoing amounts.

When the flameproof thermoplastic resin composition includes polycarbonate in an amount within this range, the thermoplastic resin composition can have proper impact strength and heat resistance.

(b) Polystyrene Resin

The polystyrene resin may be obtained by bulk polymerization, suspension polymerization, emulsion polymerization, or continuous polymerization of an aromatic vinyl monomer.

Examples of the aromatic vinyl monomer may include without limitation styrene, para-methylstyrene, α-methylstyrene, 4-N-propylstyrene, and the like, and combinations thereof. In exemplary embodiments, the aromatic vinyl monomer may include styrene, a-methylstyrene, or a combination thereof.

The polystyrene resin may have a weight average molecular weight of about 200,000 to about 400,000 g/mol, for example about 250,000 to about 350,000 g/mol.

The polystyrene resin having a weight average molecular weight within the above range functions as an emulsifier that optimizes the form and position of the impact modifier added to the polycarbonate resin to improve affinity between the polycarbonate and the impact modifier, thereby increasing dispersibility of the impact modifier. Generally, there is almost no affinity between the polycarbonate and the impact modifier, and the impact modifier cohesively agglomerates and is not uniformly dispersed, thereby making it difficult to obtain proper impact strength. Further, if the amount of the impact modifier is too much or the particle size of the impact modifier increases, appearance defects, such as yellowing, weld dichroism, and gate marks, can occur.

In the present invention the polystyrene resin can impart proper fluidity to the thermoplastic resin and allow the impact modifier to be disposed on the interface between the polycarbonate resin and the polystyrene resin so that the impact modifier is evenly dispersed in the thermoplastic resin matrix. Accordingly, the thermoplastic resin can obtain sufficient impact strength, using a small amount of the impact modifier, and can have improved coloring performance and injection molding performance, to thereby provide an excellent appearance.

The domain size of polystyrene may be determined largely by a physical mixture and a thermodynamic factor. A physical factor may include specific energy consumption (SEC) determined by a viscosity difference between polycarbonate (PC) and polystyrene (PS) and a screw RPM/process temperature. However, the physical mixture does not improve basic compatibility of a polycarbonate/polystyrene blend and thus is thermodynamically unstable. The acrylic shell containing core-shell graft copolymer (c2) exhibits medium affinity between polycarbonate and polystyrene and an acrylic domain can be disposed on the interface between polycarbonate and polystyrene. In the present invention, the acrylic shell containing core-shell graft copolymer (c2) serves as a compatibilizer for the polycarbonate/polystyrene blend to control and minimize the domain size of the polystyrene, thereby maximizing rubber dispersion. When rubber dispersibility is maximized, excellent appearance can be obtained.

The flameproof thermoplastic resin composition may include the polystyrene resin in an amount of about 1 to about 30 parts by weight, based on about 100 parts by weight of the entire composition, for example about 2 to about 20 parts by weight, and as another example about 5 to about 15 parts by weight. In some embodiments, the flameproof thermoplastic resin composition may include the polystyrene resin in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the polystyrene resin can be in a range from about any of the foregoing amounts to about any other of the foregoing amounts.

When the flameproof thermoplastic resin composition includes polystyrene in an amount within this range, the thermoplastic resin composition can exhibit maximized dispersibility of the impact modifier, proper fluidity to improve impact resistance and injection molding performance, and proper flame retardancy.

(c) Impact Modifier

(c1) Rubber Modified Vinyl Graft Copolymer

The rubber modified vinyl graft copolymer may be prepared by graft polymerization of a monomer mixture including a rubber polymer, an aromatic vinyl compound, and a vinyl cyanide compound. The rubber modified vinyl graft copolymer may include about 40 to about 70 wt % of a rubber polymer and about 30 to about 60 wt % of a vinyl monomer, wherein 100 wt % of the vinyl monomer may include about 60 to about 90 wt % of an aromatic vinyl compound and about 10 to about 40 wt % of a vinyl cyanide compound.

In some embodiments, the rubber modified vinyl graft copolymer may include the rubber polymer in an amount of about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the rubber polymer can be in a range from about any of the foregoing amounts to about any other of the foregoing amounts.

In some embodiments, the rubber modified vinyl graft copolymer may include the vinyl monomer in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt %. Further, according to some embodiments of the present invention, the amount of the vinyl monomer can be in a range from about any of the foregoing amounts to about any other of the foregoing amounts.

In some embodiments, the vinyl monomer may include the aromatic vinyl compound in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the aromatic vinyl compound can be in a range from about any of the foregoing amounts to about any other of the foregoing amounts.

In some embodiments, the vinyl monomer may include the vinyl cyanide compound in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt %. Further, according to some embodiments of the present invention, the amount of the vinyl cyanide compound can be in a range from about any of the foregoing amounts to about any other of the foregoing amounts.

Examples of the rubber polymer may include without limitation polybutadiene rubber, acrylic rubber, ethylene/propylene rubber, styrene/butadiene rubber, acrylonitrile/butadiene rubber, isoprene rubber, an ethylene-propylene-diene terpolymer (EPDM), polyorganosiloxane/polyalkyl(meth)acrylate rubber complex, and the like, and combinations thereof. In exemplary embodiments, polybutadiene rubber may be used.

The rubber polymer may have an average particle size of about 0.05 to about 0.5 μm, for example about 0.2 to about 0.35 μm. In some embodiments, the rubber polymer may have an average particle size of about 0.05, 0.06, 0.07, 0.08, 0.09, 0.1, 0.15, 0.2, 0.25, 0.3, 0.35, 0.4, 0.45, or 0.5 μm. Further, according to some embodiments of the present invention, the rubber polymer may have an average particle size in a range from about any of the foregoing amounts to about any other of the foregoing amounts.

When the rubber polymer has an average particle size within this range, excellent appearance may be obtained while maintaining proper impact strength.

Examples of the aromatic vinyl compound may include without limitation styrene, a-methylstyrene, halogen substituted styrene, C1-C10 alkyl substituted styrene, and the like, and combinations thereof. Styrene may be used in exemplary embodiments.

Examples of the vinyl cyanide compound include without limitation acrylonitrile, methacrylonitrile, and the like, and combinations thereof. Acrylonitrile may be used in exemplary embodiments.

In addition, a monomer, such as methacrylic acid C1 to C8 alkyl esters, acrylic acid C1 to C8 alkyl esters, maleic anhydride, and the like, and combinations thereof, may be further added to conduct graft-polymerization. Methacrylic acid C1 to C8 alkyl esters and acrylic acid C1 to C8 alkyl esters are alkyl esters of methacrylic acid and acrylic acid, respectively, obtained from C1 to C8 monohydroxy alcohols. Examples of methacrylic acid C1 to C8 alkyl esters and acrylic acid C1 to C8 alkyl esters may include without limitation methacrylic acid methyl ester, methacrylic acid ethyl ester, methacrylic propyl ester, acrylic acid ethyl ester, acrylic acid methyl ester, and the like, and combinations there.

Examples of the rubber modified vinyl graft copolymer may include without limitation compounds obtained by graft polymerization of polybutadiene rubber, acrylic rubber, or styrene/butadiene rubber with a mixture of styrene, acrylonitrile, and optionally a (meth)acrylic acid alkyl ester monomer.

In exemplary embodiments, an acrylonitrile butadiene styrene (ABS) graft copolymer may be used as the rubber modified graft copolymer.

(c2) Acrylic Shell Containing Core-Shell Graft Copolymer

The core-shell graft copolymer has a core-shell structure obtained via grafting an unsaturated monomer onto a core structure of rubber to form a hard shell. The core-shell graft copolymer is obtained by grafting a rubber polymer polymerized from a diene monomer, an acrylic monomer, a silicon monomer or a combination thereof with an unsaturated compound of an acrylic monomer, a heterocyclic monomer, an aromatic vinyl-monomer, an unsaturated nitrile monomer or a combination thereof, wherein the unsaturated compound includes at least one acrylic monomer.

Examples of the diene monomer may include without limitation C4 to C6 butadiene, isoprene, and the like, and combinations thereof, for example butadiene. Examples of the rubber polymer obtained by polymerization of the diene monomer may include without limitation butadiene rubber, acrylic rubber, styrene/butadiene rubber, acrylonitrile/butadiene rubber, isoprene rubber, an ethylene-propylene-diene terpolymer (EPDM), and the like, and combinations thereof.

Examples of the acrylic monomer may include without limitation methyl(meth)acrylate, ethyl(meth)acrylate, n-propyl(meth)acrylate, n-butyl(meth)acrylate, hexyl(meth)acrylate, 2-ethylhexyl(meth)acrylate, and the like, and combinations thereof. A curing agent, such as ethylene glycol di(meth)acrylate, propylene glycol di(meth)acrylate, 1,3-butylene glycol di(meth)acrylate, 1,4-butylene glycol di(meth)acrylate, allyl(meth)acrylate, triallyl cyanurate, and the like, and combinations thereof, may be used.

Examples of the silicon monomer may include without limitation hexamethyl cyclotrisiloxane, octamethyl cyclotetrasiloxane, decamethyl cyclopentasiloxane, dodecamethyl cyclohexasiloxane, trimethyltriphenyl cyclotrisiloxane, tetramethyltetraphenyl cyclotetrasiloxane, octaphenyl cyclotetrasiloxane, and the like, and combinations thereof. A curing agent, such as trimethoxymethylsilane, triethoxyphenylsilane, tetramethoxysilane, tetraethoxysilane, and the like, and combinations thereof, may be used.

The rubber polymer may have an average particle size of about 0.05 to about 0.5 μM, for example about 0.07 to about 0.15 μm. In some embodiments, the rubber polymer may have an average particle size of about 0.05, 0.06, 0.07, 0.08, 0.09, 0.1, 0.15, 0.2, 0.25, 0.3, 0.35, 0.4, 0.45, or 0.5 μm. Further, according to some embodiments of the present invention, the rubber polymer may have an average particle size in a range from about any of the foregoing amounts to about any other of the foregoing amounts.

When the rubber polymer has an average particle size within this range, excellent appearance may be obtained while maintaining proper impact strength.

Examples of the acrylic monomer of the unsaturated compounds may include without limitation (meth)acrylic acid alkyl esters, (meth)acrylic acid esters, and the like, and combinations thereof. As used herein, alkyl refers to C1 to C10 alkyl. Examples of the (meth)acrylic acid alkyl ester may include without limitation methyl(meth)acrylate, ethyl(meth)acrylate, propyl(meth)acrylate, butyl(meth)acrylate, and the like, and combinations thereof, for example methyl(meth)acrylate.

The heterocyclic monomer may include substituted or non-substituted C2 to C20 heterocycloalkyl compounds, substituted or non-substituted C2 to C20 heterocycloalkenyl compounds, and substituted or non-substituted C2 to C20 heterocycloalkynyl compounds, and the like, and combinations thereof. As used herein, the term “substituted” means that a hydrogen atom of a compound is substituted by a halogen atom, such as F, Cl, Br, and I, a hydroxyl group, a nitro group, a cyano group, an amino group, an azido group, an amidino group, a hydrazino group, a hydrazono group, a carbonyl group, a carbamyl group, a thiol group, an ester group, a carboxyl group or salt thereof, a sulfonic acid group or salt thereof, a phosphate group or salt thereof, a C1 to C20 alkyl group, a C2 to C20 alkenyl group, a C2 to C20 alkynyl group, a C1 to C20 alkoxy group, a C6 to C30 aryl group, a C6 to C30 aryloxy group, a C3 to C30 cycloalkyl group, a C3 to C30 cycloalkenyl group, a C3 to C30 cycloalkynyl group, or a combination thereof. Examples of the heterocyclic monomer may include maleic anhydride, C1-C10 alkyl or phenyl N-substituted maleimide, and the like.

Examples of the aromatic vinyl monomer may include without limitation styrene, C1 to C10 alkyl substituted styrene, halogen substituted styrene, and the like, and combinations thereof. Examples of the alkyl substituted styrene may include without limitation o-ethylstyrene, m-ethylstyrene, p-ethylstyrene, a-methylstyrene, and the like, and combinations thereof.

Examples of the unsaturated nitrile monomer may include without limitation acrylonitrile, methacrylonitrile, ethacrylonitrile, and the like, and combinations thereof.

An exemplary polymer formed from at least one monomer among these unsaturated compounds may be polymethylmethacrylate.

The core-shell structured copolymer agglomerates into a hollow spherical form in a polycarbonate and polystyrene resin matrix and is disposed on the interface between the polycarbonate resin and the polystyrene resin to maximize dispersibility, thereby providing sufficient impact resistance using a small amount of the impact modifier.

The core-shell structured copolymer may include about 30 to about 80 wt % of the rubber polymer and about 20 to about 70 wt % of the unsaturated compound grafted thereto.

In some embodiments, the core-shell structured copolymer may include the rubber polymer in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the rubber polymer can be in a range from about any of the foregoing amounts to about any other of the foregoing amounts.

In some embodiments, the core-shell structured copolymer may include the unsaturated compound in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the unsaturated compound can be in a range from about any of the foregoing amounts to about any other of the foregoing amounts.

When the core-shell structured copolymer includes rubber polymer and the unsaturated compound grafted thereto in amounts within this range, the core-shell structured copolymer can easily agglomerate into a hollow spherical form. Thus, due to its light weight, the copolymer can be trapped on the surface of the thermoplastic resin matrix, which can secure fluidity due to the polystyrene, and can thereby improve dispersibility, which can increase impact strength against an external impact.

Further, the core-shell structured copolymer may have an average particle size of about 0.07 to about 1 μm. In some embodiments, the core-shell structured copolymer may have an average particle size of about 0.07, 0.08, 0.09, 0.1, 0.2, 0.3, 0.4, 0.5, 0.6, 0.7, 0.8, 0.9, or 1 μm. Further, according to some embodiments of the present invention, the core-shell structured copolymer may have an average particle size in a range from about any of the foregoing amounts to about any other of the foregoing amounts.

When the core-shell structured copolymer has an average particle size within this range, the copolymer may be properly dispersed in the polycarbonate and polystyrene resin matrix to ease absorption of external impact, thereby improving impact modifying effects.

In exemplary embodiments, a methylmethacrylate-butadiene-styrene (MBS) copolymer may be used as the acrylic shell containing core-shell graft copolymer.

The impact modifier may include the rubber modified vinyl graft copolymer (c1) and the acrylic shell containing core-shell graft copolymer (c2) in a mixture ratio of about 1:1 to about 1:3.

In some embodiments, the impact modifier may include the rubber modified vinyl graft copolymer (c1) in an amount of about 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the rubber modified vinyl graft copolymer (c1) can be in a range from about any of the foregoing amounts to about any other of the foregoing amounts.

In some embodiments, the impact modifier may include the acrylic shell containing core-shell graft copolymer (c2) in an amount of about 50, 51, 52, 53, 54, 55, 56, 57, 58, 59, 60, 61, 62, 63, 64, 65, 66, 67, 68, 69, 70, 71, 72, 73, 74, or 75 wt %. Further, according to some embodiments of the present invention, the amount of the acrylic shell containing core-shell graft copolymer (c2) can be in a range from about any of the foregoing amounts to about any other of the foregoing amounts.

When the impact modifier includes the rubber modified vinyl graft copolymer (c1) and the acrylic shell containing core-shell graft copolymer (c2) in a mixture ratio within this range, proper surface trapping effects may be obtained to improve dispersion efficiency.

The flameproof thermoplastic resin composition may include the impact modifier in an amount of about 1 to about 30 parts by weight, based on about 100 parts by weight of the entire composition, for example about 3 to about 20 parts by weight, and as another example about 6 to about 15 parts by weight. In some embodiments, the flameproof thermoplastic resin composition may include the impact modifier in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the impact modifier can be in a range from about any of the foregoing amounts to about any other of the foregoing amounts.

When the flameproof thermoplastic resin composition includes the impact modifier in an amount within this range, the thermoplastic resin composition may exhibit proper appearance, fluidity, and impact strength.

(d) Phosphorus Flame Retardant

Examples of the phosphorus flame retardants may include without limitation phosphates, phosphonates, phosphinates, phosphine oxides, phosphazenes, metal salts thereof, and the like, and combinations thereof, for example phosphate compounds, such as aromatic phosphate ester compounds.

The aromatic phosphate ester compound may have a structure represented by Formula 2:

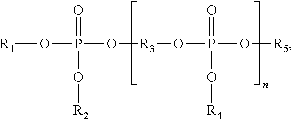

where R1, R2, R4, and R5 are each independently C6 to C20 aryl or C1 to C10 alkyl substituted aryl, R3 is derived from resorcinol, hydroquinol, bisphenol A, or bisphenol dialcohol, and n is 0 to 5.

When n is 0, the aromatic phosphate ester compound may include triphenyl phosphate, tricresyl phosphate, cresyl diphenyl phosphate, trixylyl phosphate, tri(2,4,6-trimethylphenyl)phosphate, tri(2,4-di-tert-butylphenyl)phosphate, tri(2,6-di-tert-butylphenyl)phosphate, and the like. When n is 1, the aromatic phosphate ester compound may include resorcinol bis(diphenyl phosphate), hydroquinol bis(diphenyl phosphate), bisphenol A bis(diphenyl phosphate), resorcinol bis(2,6-di-tert-butylphenyl phosphate), hydroquinol bis(2,6-dimethylphenyl phosphate), and the like. When n is 2 or higher, the aromatic phosphate ester compound may exist as a mixture in the form of an oligomer. These compounds may be used alone or in combination thereof. In exemplary embodiments, bisphenol A bis(diphenyl phosphate) (BDP) may be used.

The aromatic phosphate ester compound may be used alone or as a mixture with other phosphoric flame retardants.

The flameproof thermoplastic resin composition may include the phosphorus flame retardant (d) in an amount of about 1 to about 20 parts by weight, based on about 100 parts by weight of the base resin including (a), (b) and (c), for example about 5 to about 20 parts by weight, and as another example about 10 to about 16 parts by weight. In some embodiments, the flameproof thermoplastic resin composition may include the phosphorus flame retardant in an amount of about 1, 2, 3, 4, 5, 6, 7, 8, 9, 10, 11, 12, 13, 14, 15, 16, 17, 18, 19, or 20 parts by weight. Further, according to some embodiments of the present invention, the amount of the phosphorus flame retardant can be in a range from about any of the foregoing amounts to about any other of the foregoing amounts.

When the flameproof thermoplastic resin composition includes the phosphorus flame retardant in an amount within this range, the thermoplastic resin composition may have excellent flame retardancy and proper impact strength.

The thermoplastic resin according to the present invention may have an impact strength of about 45 to about 55 kgf·cm/cm (⅛″, ASTM D256), a melt index of about 100 to about 115 g/10 min (10 kg, 220° C., ISO 1133), and a flammability rating of V-0 (2 mm, UL94).

The flameproof thermoplastic resin composition may further include one or more additives, as needed. The additives may include, without being limited to, antioxidants, nucleating agents, surfactants, coupling agents, fillers, plasticizers, lubricants, antimicrobial agents, releasing agents, heat stabilizers, photostablizers, compatibilizers, inorganic additives, coloring agents (such as pigments, dyes, and the like), stabilizers, anti-static agents, and flame resisting agents, which may be used alone or in combination thereof.

The flameproof thermoplastic resin composition may be formed into a molded article by any known method of preparing a resin product. For example, the components and optionally one or more additives can be mixed, and the mixture can be melt-extruded and formed into pellets by an extruding machine. Then, pellets can be manufactured into molded products using known molding processes, such as plastic injection or compression. Any molding method may be used, for example, extrusion molding, injection molding, calendar molding, and vacuum molding.

The flameproof thermoplastic resin composition according to the present invention can have excellent flame retardancy, formability with a mold, impact strength, and gloss, and thus the composition may be used in manufacturing automobile components or exterior materials and housings of electric and electronic products, for example, for televisions, washing machines, cassette players, MP3 players, DMBs, navigation systems, mobile phones, telephones, game consoles, audio players, monitors, computers, printers, copiers, and the like, which require the above properties.

It should be understood that many alterations and modifications can be made by those having ordinary skill in the art without departing from the spirit and scope of the invention.

### EXAMPLES

The constitution and functions of the present invention will be explained in more detail with reference to the following examples. These examples are provided for illustrative purposes only and are not to be in any way construed as limiting the present invention. A description of details apparent to those skilled in the art will be omitted.

### Examples 1 to 4 and Comparative Examples 1 to 3

### Preparation of Thermoplastic Resin

Thermoplastic resin compositions according to Examples 1 to 4 and Comparative

Examples 1 to 3 are prepared according to compositions listed in Table 1. Details of components used in Examples and Comparative Examples are described as follows. The components according to the compositions listed in Table 1 are mixed, extruded using a general biaxial extruding machine, and formed into pellets.

(a) Polycarbonate Resin (Available from Cheil Industries Inc.)

PC-1: polycarbonate resin with a melt index of 62 g/10 min (1.2 kg, 300° C., ISO 1133)

PC-2: polycarbonate resin with a melt index of 8 g/10 min (1.2 kg, 300° C., ISO 1133)

(b) Polystyrene Resin (Available from Tairirex)

PS-1: polystyrene resin without zinc stearate, molecular weight of 310,000 g/mol

PS-2: polystyrene resin without zinc stearate, molecular weight of 260,000 g/mol

(c) Impact Modifier

g-ABS (available from Cheil Industries Inc.): Manufactured by general emulsion graft polymerization of 60 parts by weight of butadiene rubber having an average particle size of 0.31 μm with 40 parts by weight of a vinyl polymer including 75 wt % of styrene and 25 wt % of acrylonitrile.

MBS (available from R&H): BTA-731 including a rubber polymer having an average particle size of 100 nm

(d) Phosphorus Flame Retardant: Bisphenol A bis(diphenyl phosphate) (BDP), Manufactured by Daihachi.

Other Additives

0.3 parts by weight of Teflon (available from DuPont), 0.3 parts by weight of IRGANOX 245 (available from CIBA) as an antioxidant, and 0.2 parts by weight of LEBAX-140B (available from, LION CHEMTECH) as a stearate lubricant are added based on 100 parts by weight of each thermoplastic resin composition.

Extrusion Conditions

Extrusion conditions are 45φ, 240° C., with BDP being side fed.

TABLE 1

| | | | | | | Comparative | | |
|---|---|---|---|---|---|---|---|---|
| | | Example | | | | Example | | |
| | | 1 | 2 | 3 | 4 | 1 | 2 | 3 |
| (a) | PC-1 (wt %) | 86 | 87 | 76 | 77 | 91 | 87 | 60 |
| | PC-2 (wt %) | — | — | 10 | 10 | 5 | 5 | 30 |
| (b) | PS-1 (wt %) | 10 | 10 | — | — | — | — | — |
| | PS-2 (wt %) | — | — | 10 | 10 | — | — | — |
| (c) | g-ABS (wt %) | 4 | 3 | 4 | 3 | 4 | 8 | 10 |
| | MBS S-573 (phr) | 4 | 6 | 4 | 6 | — | — | — |

| | | | | | | | |
|---|---|---|---|---|---|---|---|
| BDP (phr) | 15 | 15 | 15 | 15 | 15 | 15 | 15 |

### Experimental Example

### Evaluation of Physical Properties of Thermoplastic Resins

Physical properties of resin specimens prepared in Examples 1 to 4 and Comparative Examples 1 to 3 are evaluated as follows, and results are shown in Table 2.

1. IZOD Impact Strength

IZOD impact strength is measured using a ⅛″-thick specimen according to ASTM D256.

2. Melt Index (MI)

MI (unit: g/10 min) is measured at 220° C. and 10 kg according to ISO 1133.

3. Vicat Softening Point (VSP)

Vicat softening point (° C.) is measured at 5 kg according to ISO R306.

4. Flammability Rating

Flammability rating is measured using a 2 mm-thick specimen according to the UL94 standard.

5. Spiral Flow (S/F)

The length of spiral flow of a 2 mm-thick specimen is measured at 250° C.

6. Appearance

Appearance is measured by milky mark evaluation. Each specimen is injected and milky marks appearing on the surface are counted. To determine milk marks, the specimen is observed with the naked eye under a fluorescent lamp (20 W×4) and also with an optical microscope, maximally similar to SAMEX determination conditions. In the observation with the optical microscope, a cloud accompanying a hole on the surface is determined as a milky mark. Appearance is expressed in points depending on the intensity and area of a mark: no occurrence of a milky mark is defined as 0 points and a mark having the maximum intensity is defined as 5 points. Three different parts of an injection-molded product are evaluated to determine a milky mark, and each sample gets a maximum of 15 points. The points of the three samples are summed for evaluation. The maximum is 45 points: 0 (proper) to 45 (defective).

TABLE 2

| | | | | | | Comparative | | |
|---|---|---|---|---|---|---|---|---|
| | | Example | | | | Example | | |
| Physical Properties | Unit | 1 | 2 | 3 | 4 | 1 | 2 | 3 |
| IZ (⅛″) | kgf · cm/cm | 45 | 48 | 45 | 53 | 10 | 50 | 60 |
| MI (220° C., 10 kg) | g/10 min | 48 | 50 | 50 | 50 | 45 | 48 | 60 |
| VST (5 kg) | ° C. | 97 | 96 | 97 | 96 | 100 | 98 | 95 |
| Flame retardancy (2.0 mm) | Rating | V-0 | V-0 | V-0 | V-0 | V-0 | V-0 | V-0 |
| S/F (250° C.) | cm | 34 | 36 | 35 | 37 | 28 | 31 | 34 |
| Appearance | points | 10 | 13 | 12 | 15 | 13 | 30 | 40 |

As shown in Table 2, the resins according to Examples 1 to 4 which include a PC/PS blend as a base material and use g-ABS and MBS together as an impact modifier have remarkably improved impact strength as compared with the resin according to Comparative Example 1. The resins according to Comparative Examples 2 and 3 have high impact strength but have significantly deteriorated appearance. That, is, when g-ABS is used alone, impact strength rises with increasing content of g-ABS, while appearance defects (milky marks) drastically increase. This increase in appearance defects is considered to result from reduced dispersibility of rubber. When g-ABS is used alone, dispersibility is not proper. However, when MBS is used, dispersibility is reinforced due to PC/PS interfacial trapping effects. Thus, the resins of Examples 1 to 4 involve stabilized milky mark points despite relatively high rubber content as compared with the resins of Comparative Examples 2 and 3. In particular, as to fluidity, the resins of Examples 1 to 4 have excellent appearance as compared with the resin having high fluidity according to Comparative Example 3. The resin of Comparative Example 3 exhibits excellent fluidity due to a relatively high content of low-viscosity PC but has significantly deteriorated appearance.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A flameproof thermoplastic resin composition comprising:
about 50 to about 95 parts by weight of a polycarbonate resin (a), about 1 to about 30 parts by weight of a polystyrene resin (b),
about 1 to about 30 parts by weight of an impact modifier (c), and
about 1 to about 20 parts by weight of a phosphorus flame retardant (d) based on about 100 parts by weight of the base resin including (a), (b) and (c),
wherein the polystyrene resin (b) has a weight average molecular weight of about 200,000 to about 400,000 g/mol, and the impact modifier (c) comprises a rubber modified vinyl graft copolymer (c1) containing a rubber polymer having an average particle size of about 0.05 to about 0.5 μm and an acrylic shell containing core-shell graft copolymer (c2) containing a rubber polymer having an average particle size of about 0.05 to about 0.5 μm.

2. The flameproof thermoplastic resin composition of claim 1, including the rubber modified vinyl graft copolymer (c1) and the acrylic shell containing core-shell graft copolymer (c2) in a mixture ratio of about 1:1 to about 1:3.

3. The flameproof thermoplastic resin composition of claim 1, wherein the rubber modified vinyl graft copolymer (c1) is prepared by graft polymerization of a monomer mixture comprising a rubber polymer, an aromatic vinyl compound, and a vinyl cyanide compound.

4. The flameproof thermoplastic resin composition of claim 3, wherein the acrylic shell containing core-shell graft copolymer (c2) is prepared by grafting a rubber polymer polymerized from a diene monomer, an acrylic monomer, a silicon monomer or a combination thereof with an unsaturated compound including an acrylic monomer, a heterocyclic monomer, an aromatic vinyl monomer, an unsaturated nitrile monomer or a combination thereof, wherein the unsaturated compound comprises at least one acrylic monomer.

5. The flameproof thermoplastic resin composition of claim 1, wherein the polycarbonate resin has a melt index of about 5 to about 100 g/10 min (1.2 kg, 300° C., ISO 1133).

6. The flameproof thermoplastic resin composition of claim 1, wherein the thermoplastic resin composition has an impact strength of about 45 to about 55 kgf·cm/cm (⅛″, ASTM D256), a melt index of about 100 to about 115 g/10 min (10 kg, 220° C., ISO 1133), and a flammability rating of V-0 (2 mm, UL94).

7. The flameproof thermoplastic resin composition of claim 1, wherein the resin composition further comprises at least one additive selected from the group consisting of antioxidants, nucleating agents, surfactants, coupling agents, fillers, plasticizers, lubricants, antimicrobial agents, release agents, heat stabilizers, photostabilizers, compatibilizers, inorganic additives, coloring agents, stabilizers, anti-static agents, flame resisting agents, and combinations thereof.

8. A molded article formed of the flameproof thermoplastic resin composition of claim 1.
